(19) United States
(12) Patent Application Publication
(10) Pub. No.: US 2011/0179781 A1
(43) Pub. Date: Jul. 28, 2011

(54) HYDRAULIC DRIVE SYSTEM FOR USE IN DRIVEN SYSTEMS

(76) Inventors: Charles Leon Fant, Honea Path, SC (US); Danny Miles, Florence, SC (US); James Daniel Bass, Florence, SC (US)

(21) Appl. No.: 12/694,704

(22) Filed: Jan. 27, 2010

(51) Int. Cl. F16D 31/00; F03G 6/00; F04B 35/04; F04B 49/00

(52) U.S. Cl. 60/327; 60/641.8; 417/410.1; 417/280

(57) ABSTRACT

A hydraulic drive system for use in driving a power generator has a hydraulic pump having an input for rotationally driving the hydraulic pump, a flow control valve in fluid communication with the hydraulic pump, a hydraulic motor having a first output and a second output coupled to a hydraulic fluid source, and a pressure regulator positioned intermediate the flow control valve and the hydraulic motor. The pressure regulator is in fluid communication with the hydraulic motor and the flow control valve, and maintains a hydraulic pressure at its input that is higher than at its output to prevent the hydraulic system from stalling. The system further comprises a power generator having an input shaft rotationally coupled to the hydraulic motor first output.

### FIELD OF THE INVENTION

The present invention relates generally to power systems. More particularly, the present invention relates to a hydraulic power drive system for use in driving systems. In even more particularity, the present invention relates to a solar powered hydraulic drive system for use in driving a turbine generator to produce electricity.

### BACKGROUND

The rapid expansion in electrical technology over the past 200 years transformed industry and society. Electricity's extraordinary versatility as a source of energy means it can be put to an almost limitless set of applications which include transport, heating, lighting, communications, and computation. The backbone of modern industrial society is, and for the foreseeable future can be expected to remain, the use of electrical power.

Electricity has greatly enhanced people's lives and made an enormous improvement to society. However, demand for electricity has led to massive consumption of all kinds of fossil fuels, such as oil, coal and gas. These resources are rapidly depleting, and in the process have a large impact on the environment. Various influences from the carbon footprint of electricity generation plants such as greenhouse effect, El Nino phenomenon, pollutions, desertification, acid rain and extinction of certain species can be linked to society's thirst for electricity. The effect of current electricity production has led the science community to seek alternative forms of energy production to replace, or at the very least reduce the reliance on fossil fuels.

Alternative and renewable energies such as wind power, solar power and tidal power are power generation methods characterized as being pollution free and recyclable. Wind power has been in use for centuries, and windmills were used to grind wheat for producing flour. Windmills have been applied to generate wind power and to replace some of the capacities of the thermal power plant to reduce the consumption of fossil fuel. However, wind power has its own limitations and therefore it cannot effectively replace the use of fossil fuel power. First, wind power requires a sufficient wind source; therefore, location, season and weather are all related factors. Second, the transfer efficiency of wind power is low; consequently, the wind turbine must be properly scaled in order to achieve the required capacity. This can be problematic when anything other than a small amount of power is needed as large wind turbine structures can cause difficulties with installation, maintenance and mobility.

Solar power generation is yet another alternative to fossil fuel power. Solar power is the conversion of sunlight to electricity either directly into electricity using photovoltaics (PV), or indirectly with concentrating solar power (CSP), which normally focuses the sun's energy to boil water which is then used to provide power. Photovoltaics were initially used to power small and medium-sized applications, from the calculator powered by a single solar cell to off-grid homes powered by a photovoltaic array. The use of solar power for large scale power generation face high installation costs, although this has been decreasing.

Solar power is one of the more desirable types of renewal energy. For years it has been touted as one of the most promising for our increasingly industrialized society. Even though, theoretically, the amount of solar power available far exceeds most, if not all, other energy sources (renewable or not), practical challenges to utilizing this energy still remain. In general, solar power remains subject to a number of limitations that have kept it from fulfilling the promise it holds. In one regard, it has been a challenge to implement in a manner that provides adequate electrical output as compared to its cost. Solar power is a predictably intermittent energy source, meaning that while solar power is not available at all times, spare solar energy may be stored in batteries or in the form of heat which is later made available overnight or during periods that solar power is not available to produce electricity. Although power storage is possible, the costs involved in conjunction with solar energy is typically cost prohibitive.

The present invention addresses an important aspect of the use of renewable energy for generating electricity that significantly increases the ability to cost-effectively permit solar power to be harnessed, so that it may become a cost-effective source of generating electricity.

### SUMMARY OF THE INVENTION

The present invention recognizes and addresses disadvantages of prior art constructions and methods, and it is an object of the present invention to provide an improved hydraulic drive system for generating power. This and other objects may be achieved by a drive system for use in driving a load, comprising a drive unit having an output shaft and a hydraulic drive system. The hydraulic drive system has a hydraulic pump having a first input coupled to the drive unit, a second input fluidly coupled to a hydraulic fluid source, and a first output. A flow control valve is in fluid communication with the hydraulic pump first output. A hydraulic motor has a first input in fluid communication with the flow control valve, a first output operatively coupled to a load, and a second output in fluid communication with the hydraulic fluid source. A pressure regulator is positioned intermediate the flow control valve and the hydraulic motor, wherein the pressure regulator is configured to maintain a hydraulic pressure between the hydraulic pump and the pressure regulator at a first predetermined value and a hydraulic pressure between the pressure regulator and the hydraulic motor at a second predetermined value, and the first predetermined value is greater than the second predetermined value.

In other embodiments, a one-way check valve is positioned intermediate the hydraulic pump and the pressure regulator, wherein the one-way check valve is connected in parallel with the flow control valve. In still other embodiments, the drive unit is an electric motor having an output shaft that is rotationally coupled to the hydraulic pump first input. In some of these embodiments, the electric motor is an AC motor. In other of these embodiments, the electric motor is a DC motor.

In yet other embodiments, the load further comprises a power generator having an input shaft that is rotationally coupled to the hydraulic motor first output. In still other embodiments, an energy source drives the electric motor. In some of these embodiments, the energy source further comprises a solar panel, a first battery operatively coupled to the solar panel output, a power inverter operatively coupled to the battery for inverting the battery DC signal to an AC signal, a charger operatively coupled to the power inverter, a second battery operatively coupled to the charger and the electric motor, wherein the second battery is configured to power the electric motor. In some of these embodiments, the first battery provides a 12-volt DC signal, the inverter converts the 12-volt signal into a 120-volt AC signal, the charger outputs a 48-volt DC signal to charge the second battery, and the second battery outputs a 48-volt DC signal. In yet other of these embodiments, the first battery comprises a plurality of batteries, the charger comprises a plurality of 24-volt charges, and the second battery comprises a plurality of 24-volt batteries, each of the 24-volt batteries being operatively coupled to a respective one of the plurality of 24-volt chargers, wherein the at least two of the plurality of 24-volt batteries are operatively connected to power the electric motor.

In still other embodiments, the load is a vehicle. In other embodiments, the hydraulic drive further comprises a speed sensor operatively coupled to the hydraulic motor first output, and a controller operatively coupled to the speed sensor and the drive unit, wherein the controller is configured to change the operating parameters of the drive unit based on a signal received from the speed sensor.

In another preferred embodiment of the present invention, a hydraulic drive system for use in driving a power generator comprises a hydraulic drive system having a hydraulic pump having a first input for rotationally driving the hydraulic pump, a second input in fluid communication with a hydraulic fluid source, and a first output. A flow control valve has an input in fluid communication with the hydraulic pump first output and an output. A hydraulic motor has a first input in fluid communication with the flow control valve output, a first output, and a second output operatively coupled to the hydraulic fluid source. A pressure regulator is positioned intermediate the flow control valve and the hydraulic motor, wherein an input of the pressure regulator is in fluid communication with the flow control valve output and an output is in fluid communication with the hydraulic motor first input. A power generator having an input shaft rotationally coupled to the hydraulic motor first output. The pressure regulator is configured to maintain a hydraulic pressure between the hydraulic pump and the pressure regulator at a first predetermined value and a hydraulic pressure between the pressure regulator and the hydraulic motor at a second predetermined value, and the first predetermined value is greater than the second predetermined value.

In some embodiments, a drive source has an output shaft that is rotationally coupled to the hydraulic pump first input. In still other embodiments, the system further comprises a one-way check valve having an input in fluid communication with the pump first output and an output in fluid communication with the pressure regulator input. In some of these embodiments, the drive source further comprises a solar panel for providing energy to power the drive source. In these embodiments, the solar panels charge at least one battery that is used to power the drive source. In other embodiments, the drive source is wind powered.

In still another preferred embodiment, a hydraulic drive system for use in driving a power generator comprises a hydraulic drive system having a hydraulic pump having an input for rotationally driving the hydraulic pump, a flow control valve in fluid communication with the hydraulic pump, a hydraulic motor having a first output and a second output coupled to the hydraulic fluid source, and a pressure regulator positioned intermediate the flow control valve and the hydraulic motor. The pressure regulator is in fluid communication with the hydraulic motor and the flow control valve, and maintains a high hydraulic pressure at its input that is higher than at its output, to prevent the hydraulic system from stalling. The system further comprises a power generator having an input shaft rotationally coupled to the hydraulic motor first output.

In yet other embodiments, the hydraulic drive system further comprises a hydraulic fluid cooler in fluid communication with a third output of the hydraulic motor, wherein an output of the hydraulic fluid cooler is in fluid communication with a hydraulic fluid source that is in fluid communication with the hydraulic pump.

In other embodiments, an electric motor has an output shaft rotationally coupled to the input of the hydraulic pump.

Various combinations and sub-combinations of the disclosed elements, as well as methods of utilizing same, which are discussed in detail below, provide other objects, features and aspects of the present invention.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a high level block diagram of a power generation system in accordance with one embodiment of the present invention;

FIG. 2 is a schematic view of a power source in accordance with one embodiment of the present invention for use in the power generation system shown in FIG. 1;

FIG. 3 is a schematic view of a hydraulic drive system in accordance with one embodiment of the present invention for use in the power generation system shown in FIG. 1;

FIG. 4 is a front elevation view of a turbine generator for use in the power generation system shown in FIG. 1;

FIG. 5 is a side elevation view of the turbine generator shown in FIG. 4; and

FIG. 6 is a schematic diagram of the hydraulic drive system of FIG. 3 in accordance with another embodiment of the present invention.

Repeat use of reference characters in the present specification and drawings is intended to represent same or analogous features or elements of the invention according to the disclosure. The accompanying drawings, which are incorporated in and constitute a part of this specification, illustrate one or more embodiments of a hydraulic drive system of the present invention.

Various combinations and sub-combinations of the disclosed elements, as well as methods of utilizing same, which are discussed in detail below, provide other objects, features and aspects of the present invention.

### DETAILED DESCRIPTION OF THE PREFERRED EMBODIMENT

Reference will now be made in detail to presently preferred embodiments of the invention, one or more examples of which are illustrated in the accompanying drawings. Each example is provided by way of explanation, not limitation, of the invention. It is to be understood by one of ordinary skill in the art that the present discussion is a description of exemplary embodiments only, and is not intended as limiting the broader aspects of the present invention, which broader aspects are embodied in the exemplary constructions. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

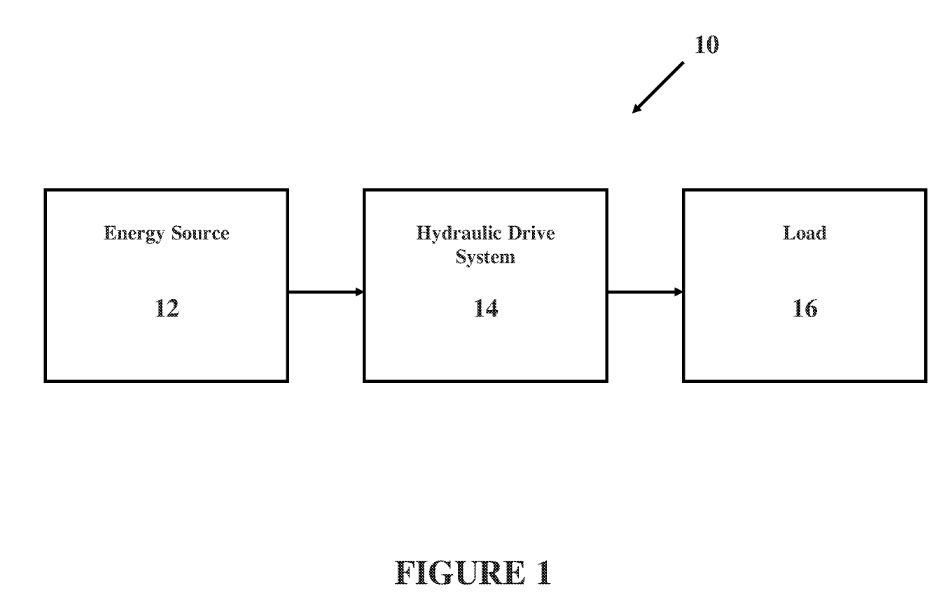

Referring to FIG. 1, a power generation system 10 is shown having an energy source 12, a hydraulic drive system 14 and a driven load 16. It should be understood that energy source 12 may be any suitable energy source for providing power to operate hydraulic drive system 14. In addition, driven load 16 may be any load with a rotational mechanical input such as an input shaft, an input gear or any other suitable mechanical input that accepts input torque.

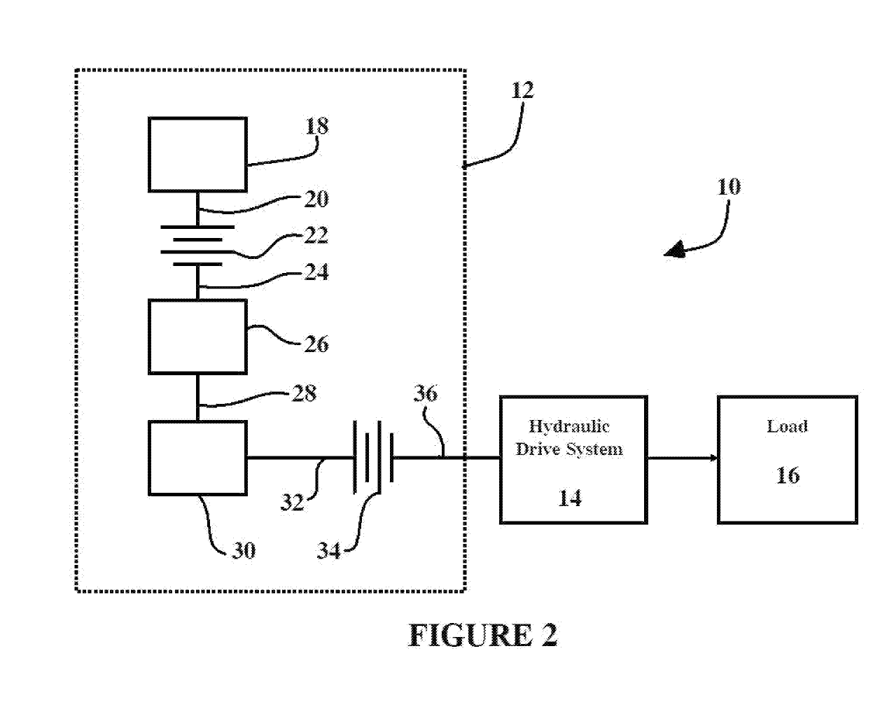

Referring to FIG. 2, power source 12 is shown having a solar panel 18, which may be of a suitable size necessary to provide sufficient output power based on the intended use of the system. In one preferred embodiment, solar panel 18 is a 12-volt, 1.5-amp panel. In commercial applications, solar panel 18 would be a 24-volt, 7.93-amp panel or panels. The output of solar panel 18 is electrically coupled by a line 20 to a battery bank 22 consisting of 8, 6-volt batteries configured to an output of 12-volts. Direct current from battery bank 22 is electrically coupled to an inverter 26 by a line 24 that inverts the electrical signal to a 120-volt, 7.65-amp electrical signal. Inverter 26 is a model no. APS2424 inverter manufactured by TRIPP LITE of Chicago Ill. The output of inverter 26 is delivered over line 28, to two parallel 24-volt trickle chargers 30 that each respectively charge a bank of 24-volt batteries 34 in parallel with one another. In one embodiment, charger 30 may be a model no. SVR24251205/6 charger, manufactured by GND Industrial Power Products of Aurora, Ill., with a 24-volt, 3-amp output. Battery bank 34 may be formed from a plurality of 8, 6-volt DC batteries, for example, model no. Type EO batteries manufactured by Champion. The output of battery bank 34 is a 48-volt, 8.75-amp signal that is output on line 36 to hydraulic drive system 14.

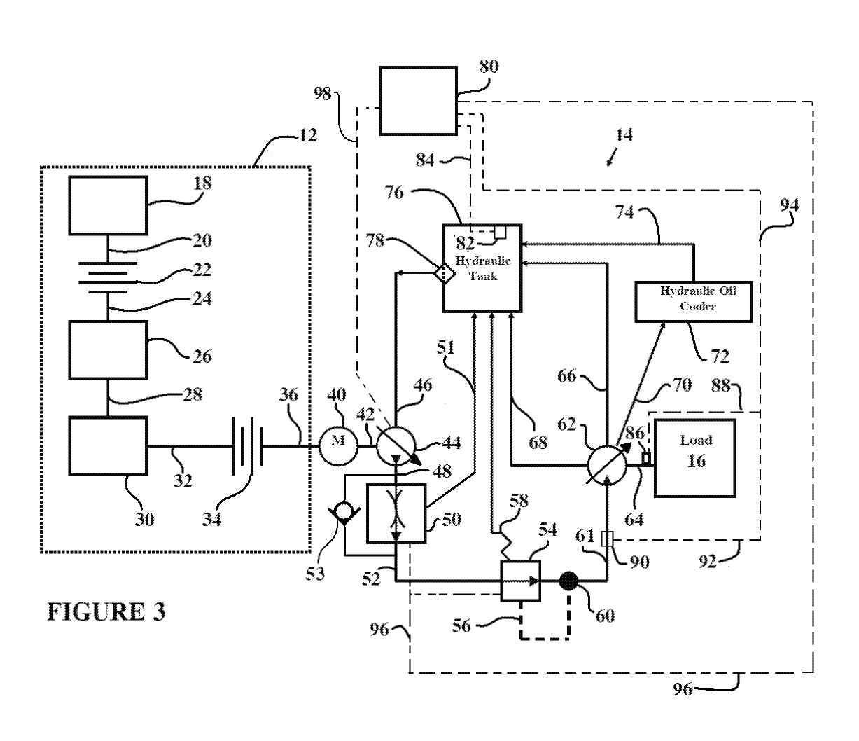

Referring to FIG. 3, hydraulic system 14 is shown having a dc/ac motor 40 electrically coupled to power source 12 by line 36, and an output shaft 42 mechanically coupled to a directional hydraulic pump 44. In one embodiment, DC/AC motor 40 is an 11 horsepower variable speed Hitachi DC motor, and hydraulic pump 44 is a vane type pump, model no. Sunstrand 46 manufactured by Parker Hannifin, of Greenville, Tenn. In the embodiment shown in FIG. 3, DC/AC motor 40 can produce up to 3600 RPMs, and pump 44 can generate at least 25 gallons/minute of fluid flow. It should be understood that hydraulic system 14 is a closed system. However, in some applications, the system may be an open system.

Hydraulic pump 44 is fluidly coupled to a flow valve 50 and a check valve 53 (described in more detail herein) by a hydraulic line 48. Flow valve 50 is configured to control the flow of hydraulic fluid in the system and allow for the system pressure to rise evenly when starting from an off position. That is, when hydraulic pump 44 is activated, it begins to operate in a no-load configuration since flow control valve 50 may dump hydraulic fluid into a hydraulic tank reservoir over a return line 51. As the flow rate increases, hydraulic actuators respond to changes in flow and will open/close the valve accordingly. In one preferred embodiment, flow control valve 50 is a Bran Hydraulics Commercial valve serial no. 2009800 mechanical flow control valve with a three-quarter inlet, outlet and return line. It should be understood by those of skill in the art that flow control valve 50 may consist of any suitable flow control valve such as a proportional flow control valve and electromechanical flow control valves.

The output of flow control valve 50 and check valve 53 is coupled to an input of a pressure regulator 54. The output of pressure regulator 54 is coupled to an input of a hydraulic motor 62 by a hydraulic line 61. Pressure regulator 54 senses the pressure on output line 61 and regulates the pressure differential between output line 61 and input line 52 by diverting input pressure onto return line 58. In one preferred embodiment, pressure regulator 54 is configured to maintain a 100 psi differential between the regulator output and input pressure to prevent stalling of the system. It should be understood that other pressure differentials are within the scope of the present invention depending on load 16. In one preferred embodiment, pressure regulator 54 is a Brad Hydraulics Commercial valve with a ¾ variable pressure adjust.

A pressure sensor 90 is positioned intermediate the output of pressure regulator 54 and the input of hydraulic motor 62 to sense the hydraulic pressure in line 61. An output of pressure sensor 90 may be coupled to a controller 80, which may use the pressure reading to control pressure regulator 54, flow control valve 50 and/or DC/AC motor 44 to maintain the pressure within hydraulic drive system 14. Controller 80 may include an input keyboard, an output display and various other controls and communication ports for remote monitoring and control.

Hydraulic motor 62 is a directional vane driven piston 25 gal/minute minimum motor. In one preferred embodiment, hydraulic motor 62 is a Sunstrand 46 hydraulic motor rated at 20/25 gallons per minute with an output speed of 2000 RPMs. An output of hydraulic motor 62 is coupled to an output line 66 that terminates in hydraulic tank reservoir 76. Hydraulic motor 62 also has a return line 68 that couples to hydraulic tank 76, in addition to an output line 70 that couples to a hydraulic cooler 72. Hydraulic oil cooler 72 is coupled to hydraulic tank 76 by line 74. An output shaft 64 of hydraulic motor 62 is rotatably coupled to an input of load 16.

A speed sensor 86 is operatively coupled to hydraulic motor output shaft 64 and is configured to sense the rotational speed of output shaft 64. An output signal of speed sensor 86 is output to controller 80 over line 88 and 94. The speed sensor output signal may be used by controller 80 to send a control signal over a line 96 and 98 to change the operation of flow control valve 50, pressure regulator 54 and DC/AC motor 44 to maintain the rotational speed of output shaft 64 based on load demands.

A temperature sensor 82 may be mounted in hydraulic tank reservoir 76 to monitor the hydraulic fluid temperature in hydraulic drive system 14. A signal generated by temperature sensor 82 is input over line 84 to controller 80.

A hydraulic output line 46 couples an output of hydraulic tank reservoir 76 with an input of hydraulic pump 44. A filter 78, located proximate to hydraulic tank reservoir 76 is placed in line with hydraulic line 46 to remove contaminants prior to entering hydraulic pump 44. Filter 78 may be any type of hydraulic fluid filter, and in one embodiment, filter 78 is a strainer type filter.

In the described embodiment, hydraulic lines 46, 48 52, 61 and 66 are one inch diameter lines. Hydraulic lines 51, 58, 68 and 70 are one-half inch diameter lines. In one preferred embodiment, hydraulic lines 46, 48, 52, 61 and 66 are Gates Hydraulic one inch 3000 psi hoses. It should be understood that other line sizes and types may be used depending on the parameters of the overall system.

It should also be understood that other types of motors may be used. For example, geared pumps, piston pumps or any other suitable hydraulic pump may be used. In one preferred embodiment, the hydraulic pump is a vane driven piston type pump. It should also be understood to those skilled in the art that a hydraulic motor may be used in place of the pump and vis-à-vis.

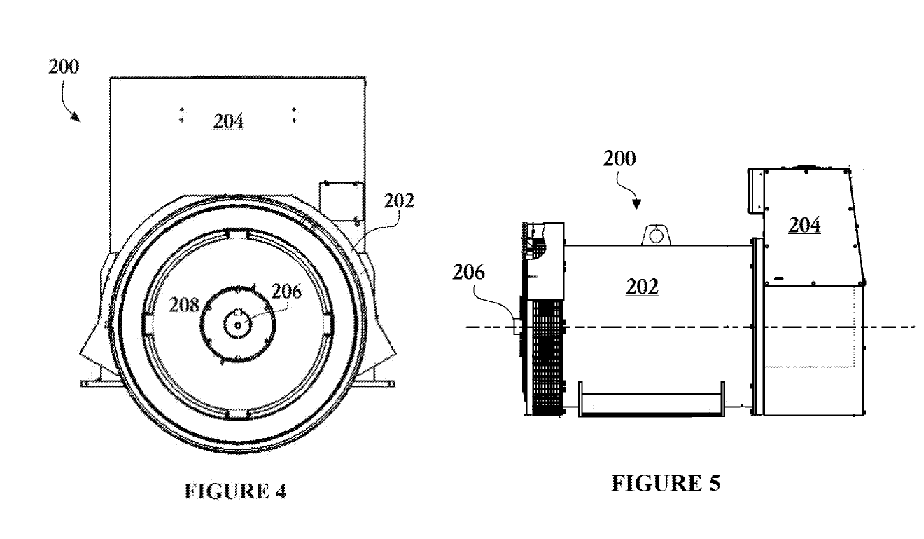

As previously discussed, load 16 may be any load that accepts an input torque. In one preferred embodiment and referring to FIGS. 4 and 5, load 16 is a 200-kWatt generator 200, model no. 70-4003, manufactured by Marathon Electric Manufacturing Corporation. Generator 200 has a generator portion 202 coupled to a conduit box 204. One of skill in the art will understand that generator portion 202 comprises a series of magnets fixed in a housing that surrounds a rotor with fixed windings. A rotor shaft 206 is rotationally fixed to a drive disc 208. Generator 200 provides a three phase electrical output each at 450 volts and 100 amps, with 1500 RPMs on rotor shaft 206. In the embodiment shown in FIGS. 4-5, an adapter is used to couple the rotor shaft to hydraulic motor output shaft 64 (FIG. 3). In some embodiments, a double bearing generator may be used, and in other embodiments a single bearing generator may be used. The type of generator will drive the structure of the adapter necessary to couple output shaft 64 to the generator rotor shaft.

Referring to FIGS. 3, 4 and 5, when hydraulic drive system 14 is switched to the off position, load 16 may continue to rotate due to centrifical force on rotor shaft 206. That is, hydraulic motor output shaft 64 will continue to freewheel with rotor shaft 206 causing a vacuum pressure to develop in hydraulic line 61 thereby draining all hydraulic fluid from hydraulic lines 61 and 52 resulting in a dry shutdown. Dry shutdowns are undesirable since they increase the wear on hydraulic motor 62 and its internal components. Thus, to prevent a dry shutdown, check valve 53 allows hydraulic fluid to flow through hydraulic lines 48, 52 and 61 by bypassing flow control valve 50 after the system is shut down. Hydraulic fluid is only allowed to flow through check valve 53 toward hydraulic motor 62 when the vacuum pressure in hydraulic line 61 is above a predetermined cracking pressure. Check valve 53 also allows fluid to remain in the hydraulic lines after the system comes to rest, which results in smoother start-ups and allows the system to reach the proper operating pressure faster after start-up.

In another preferred embodiment, energy source 12 may be eliminated and DC/AC motor 40 may be replaced with an AC motor. For example, in one preferred embodiment, a Baldor 10-hp, 230-volt, 27.6-amp AC motor may be used to drive hydraulic pump 44. At 1700 RPMs, and at 30 amps, generator 200 produces three phase 450-volt output at 100 amps peak per generator leg. In yet another embodiment, a 15-hp, 230-volt AC motor was used to drive hydraulic pump 44. In this embodiment, the AC motor operated below its maximum RPM rating with an increase in current drawn by the motor. Thus, it should be understood that various size AC motors may be used to drive hydraulic pump 44 depending on the operating parameters of system 10 (FIG. 1).

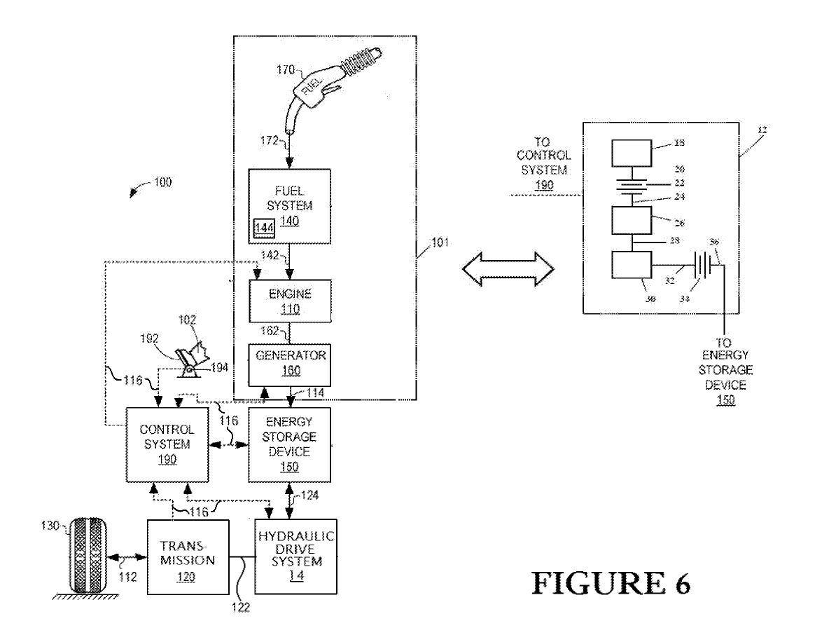

Referring to FIG. 6, a hybrid vehicle 100 is shown having an energy source 101 operatively coupled to an energy storage system 150. An output of energy storage system 150 is operatively coupled to hydraulic drive system 14. The output of hydraulic drive system 14 is coupled to an input of a transmission 120, whose output drives a tire 130 by a connection 112. A control system 190 is operatively coupled to energy storage device 150, hydraulic drive system 14, transmission system 120, energy source 101 and a control mechanism 192 via lines 116.

In one preferred embodiment, energy source 101 has a fuel system 140 that receives fossil fuel 170 via an input line 172. Fuel system 140 provides fossil fuel to an engine 110 over a fuel line 142. An output of engine 110 is operatively coupled to a generator 160 over line 162 that provides energy to energy storage device 150 over line 114. Engine 110 and generator 160 are coupled to control system 190 via lines 116.

In operation, control system 190 is programmed to receive input from an input device 192 via the user of the vehicle. Based on the user's input, control system 190 directs hydraulic drive system to provide output torque to transmission 120 over line 116. Control system 190 also directs the operation of transmission 120 to move the vehicle forward or reverse based on the user's input. Control system 190 also directs energy source 101 to generate electric power that can be stored in energy storage device 150. In other embodiments, energy source 101 may be replaced with energy source 12, which would also be controlled by control system 190.

It should be understood that various sensors would be necessary to provide data input to control system 190 so that the operation of the vehicle can be properly controlled. For example, a level sensor may be operatively coupled to control system 190 to provide information about the grade of the terrain. This information is useful in determining the required torque necessary to move the vehicle up an incline. Additionally, speed and temperature sensors may also be necessary to properly control hybrid vehicle 100, as is know in the art.

While one or more preferred embodiments of the invention are described above, it should be appreciated by those skilled in the art that various modifications and variations can be made in the present invention without departing from the scope and spirit thereof. For example, hybrid hydraulic drive system 14 and energy source 12 may be used to propel various types of loads, such as various generators, vehicles, water craft, etc. It is intended that the present invention cover such modifications and variations as come within the scope and spirit of the appended claims and their equivalents.

What is claimed is:

1. A drive system for use in driving a load, comprising:
a. a drive unit having an output shaft;
b. a hydraulic drive system comprising;
(i) a hydraulic pump having;
a first input coupled to the drive unit,
a second input fluidly coupled to a hydraulic fluid source, and
a first output;
(ii) a flow control valve in fluid communication with said hydraulic pump first output;
(iii) a hydraulic motor having;
a first input in fluid communication with said flow control valve,
a first output operatively coupled to a load, and
a second output operatively coupled to said hydraulic fluid source; and
(iv) a pressure regulator positioned intermediate said flow control valve and said hydraulic motor,
wherein
said pressure regulator is configured to maintain a hydraulic pressure between said hydraulic pump and said pressure regulator at a first predetermined value and a hydraulic pressure between said pressure regulator and said hydraulic motor at a second predetermined value, and
said first predetermined value is greater than said second predetermined value.

2. The hydraulic drive system of claim 1, further comprising a one-way check valve positioned intermediate said hydraulic pump and said pressure regulator, wherein said one-way check valve is connected in parallel with said flow control valve.

3. The hydraulic drive system of claim 1, wherein said drive unit is an electric motor having an output shaft that is rotationally coupled to said hydraulic pump first input.

4. The hydraulic drive system of claim 3, wherein said electric motor is an AC motor.

5. The hydraulic drive system of claim 1, wherein said load further comprises a power generator having an input shaft that is rotationally coupled to said hydraulic motor first output.

6. The hydraulic drive system of claim 3, further comprising an energy source to drive said electric motor.

7. The hydraulic drive system of claim 6, said energy source further comprising:
a. a solar panel;
b. a first battery operatively coupled to an output of said solar panel;
c. a power inverter operatively coupled to said battery for inverting said battery DC signal to an AC signal;
d. a charger operatively coupled to said power inverter; and
e. a second battery operatively coupled to said charger and said electric motor, wherein said second battery is configured to power said electric motor.

8. The hydraulic drive system of claim 7, wherein:
a. said first battery provides a 12 volt DC signal;
b. said inverter converts said 12 volt signal into a 120V AC signal;
c. said charger receives said 120V AC signal and outputs a 48 volt DC signal to charge said second battery; and
d. said second battery outputs a 48 volt DC signal to said electric motor.

9. The hydraulic drive system of claim 7, wherein:
a. said first battery comprises a plurality of batteries;
b. said charger comprises a plurality of charges; and
c. said second battery comprises a plurality of batteries, each of said batteries being operatively coupled to a respective one of said plurality of chargers,
wherein said at least two of said plurality of batteries are operatively connected to power said electric motor.

10. The hydraulic drive system of claim 1, wherein said load is a vehicle.

11. The hydraulic drive system of claim 1, further comprising:
a. a speed sensor operatively coupled to said hydraulic motor first output; and
b. a controller operatively coupled to said speed sensor and said drive unit,
wherein said controller is configured to change the operating parameters of said drive unit based on a signal received from said speed sensor.

12. A hydraulic drive system for use in driving a power generator comprising:
a. a hydraulic pump having;
(i) a first input for rotationally driving said hydraulic pump,
(ii) a second input fluidly coupled to a hydraulic fluid source, and
(iii) a first output;
b. a flow control valve having an output and an input in fluid communication with said hydraulic pump first output;
c. a hydraulic motor having;
(i) a first input in fluid communication with said flow control valve output,
(ii) a first output, and
(iii) a second output operatively coupled to said hydraulic fluid source;
d. a pressure regulator positioned intermediate said flow control valve and said hydraulic motor, wherein an input of said pressure regulator is in fluid communication with said flow control valve output and an output of said pressure regulator is in fluid communication with said hydraulic motor first input, wherein said pressure regulator is configured to maintain a higher hydraulic pressure at its input than at its output; and
e. a power generator having an input shaft rotationally coupled to said hydraulic motor first output.

13. The hydraulic drive system of claim 12, further comprising a drive source having an output shaft that is rotationally coupled to said hydraulic pump first input.

14. The hydraulic drive system of claim 12, further comprising a one-way check valve having an input in fluid communication with said pump first output and an output in fluid communication with said pressure regulator input.

15. The hydraulic drive system of claim 13, wherein said drive source further comprises a solar panel for providing energy to power said drive source.

16. The hydraulic drive system of claim 15, wherein said solar panel charges at least one battery that is used to power said drive source.

17. The hydraulic drive system of claim 13, wherein said drive source is wind powered.

18. A hydraulic drive system for use in driving a power generator comprising:
a. a drive unit having an output shaft;
b. a hydraulic pump having an input for rotationally driving said hydraulic pump,
wherein said input is rotationally coupled to said drive unit output shaft;
c. a flow control valve in fluid communication with said hydraulic pump;
d. a hydraulic motor having a first output and a second output coupled to said hydraulic fluid source;
e. a pressure regulator positioned intermediate said flow control valve and said hydraulic motor, wherein said pressure regulator is in fluid communication with said hydraulic motor and said flow control valve, and maintains a hydraulic pressure at its input that is higher than the hydraulic pressure at its output to prevent the hydraulic system from stalling; and
f. a power generator having an input shaft rotationally coupled to said hydraulic motor first output.

19. The hydraulic drive system of claim 18, further comprising a hydraulic fluid cooler in fluid communication with a third output of said hydraulic motor, wherein an output of said hydraulic fluid cooler is in fluid communication with a hydraulic fluid source that is in fluid communication with said hydraulic pump.

20. The hydraulic drive system of claim 18, wherein said drive unit is an electric motor.
